(19) United States
(12) Patent Application Publication
(10) Pub. No.: US 2026/0076507 A1
(43) Pub. Date: Mar. 19, 2026

(54) OUTDOOR CONVECTIVE FOOD COOKER

(71) Applicant: FC Industries, LLC, Atlanta, GA (US)

(72) Inventors: Christian Evan Fitzgerald, Atlanta, GA (US); David Paul Horvath, Canton, MI (US)

(21) Appl. No.: 19/334,086

(22) Filed: Sep. 19, 2025

Related U.S. Application Data
(60) Provisional application No. 63/696,655, filed on Sep. 19, 2024.

(51) Int. Cl. A47J 37/07

(52) U.S. Cl. CPC A47J 37/0704

(57) ABSTRACT

A food cooker includes a cooking chamber; a furnace chamber disposed below the cooking chamber; a lid covering a top opening of the cooking chamber, the lid and the cooking chamber defining an enclosed cavity; and a food-supporting element within the enclosed cavity. A method of cooking a food item includes providing a food cooker, the food cooker comprising: a cooking chamber; a furnace chamber disposed below the cooking chamber; a lid covering a top opening of the cooking chamber, the lid and the cooking chamber defining an enclosed cavity; and a food-supporting element within the enclosed cavity; receiving charcoal within the furnace chamber; igniting the charcoal; supporting a food item on the food-supporting element within the enclosed cavity; and heating an interior of the enclosed cavity with the ignited charcoal to cook the food item.

### CROSS-REFERENCE TO RELATED APPLICATIONS

The present application claims the benefit of U.S. Provisional Ser. No. 63/696,655, filed Sep. 19, 2024, which is hereby specifically incorporated by reference herein in its entirety and for all purposes.

### TECHNICAL FIELD

This disclosure relates to a convective cooking device configured to smoke meat and other types of food more efficiently than conventional smoking methods.

### BACKGROUND

A multitude of outdoor cookers have been created, presumably in hopes of improving the culinary quality and/or the ease of the cooking. While outdoor cookers tailored toward smoking meat are valued for their effectiveness and taste, they also typically take long periods of time to finish cooking. Consequently, advancements in improving various features and the efficiency with which meat is smoked is desirable.

The subject matter claimed in the present disclosure is not limited to implementations that solve any disadvantages or that operate only in environments such as those described above. Rather, this background is only provided to illustrate one example technology area where some embodiments described in the present disclosure may be practiced.

### SUMMARY

Disclosed are various embodiments that related to various methods and devices for smoking meat.

A food cooker is disclosed, the food cooker comprising a cooking chamber; a furnace chamber disposed below the cooking chamber; a lid covering a top opening of the cooking chamber, the lid and the cooking chamber defining an enclosed cavity; and a food-supporting element within the enclosed cavity.

Also disclosed is a method of cooking a food item, the method comprising providing a food cooker, the food cooker comprising: a cooking chamber; a furnace chamber disposed below the cooking chamber; a lid covering a top opening of the cooking chamber, the lid and the cooking chamber defining an enclosed cavity; and a food-supporting element within the enclosed cavity; placing charcoal within the furnace chamber; igniting the charcoal; supporting a food item on the food-supporting element within the enclosed cavity; and heating an interior of the enclosed cavity with the ignited charcoal to cook the food item.

Other aspects and advantages of the described embodiments will become apparent from the following detailed description taken in conjunction with the accompanying drawings which illustrate, by way of example, the principles of the described embodiments.

### BRIEF DESCRIPTION OF THE DRAWINGS

Example embodiments will be described and explained with additional specificity and detail through the use of the accompanying drawings in which:

FIG. 1 shows a perspective view of an exterior of a food cooker;

FIG. 2 shows a cross-sectional side view of the food cooker shown in FIG. 1; and

FIG. 3 shows a perspective view of the food cooker shown in FIGS. 1 and 2 with interior components indicated by dashed lines.

### DETAILED DESCRIPTION

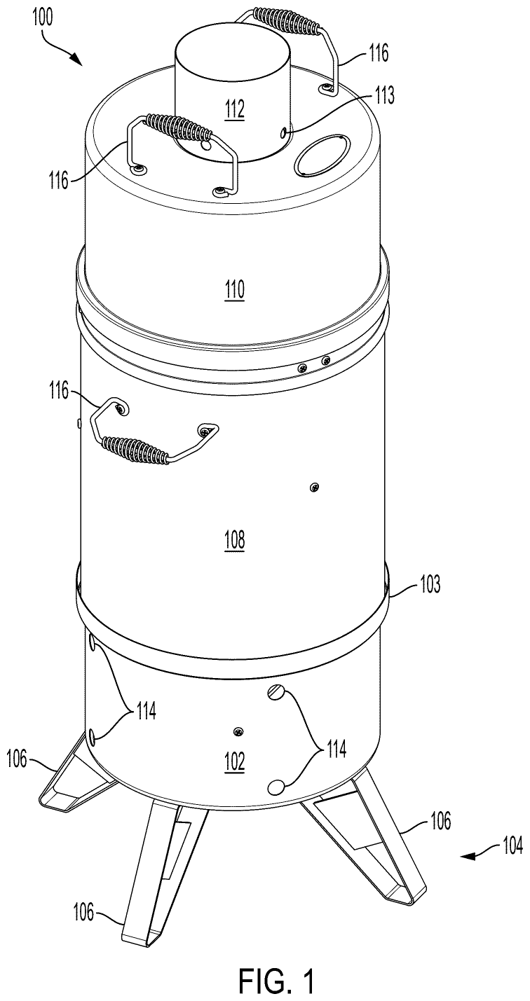

FIG. 1 shows a perspective view of an exterior of a food cooker 100 well suited for quickly smoking and/or cooking meat. Food cooker 100 can comprise a furnace chamber 102 elevated above a supporting surface by a support stand 104 that includes at least three legs 106. In the present aspect, the food cooker 100 can comprise four legs 106, for example and without limitation. As depicted, legs 106 can extend radially outward from furnace chamber 102 but support stand 104 could instead take the form of multiple vertical legs or a unitary pole stand depending on the preference of a consumer, for example and without limitation. In some embodiments, support stand 104 can be swappable with other types of support stands. In general, support stand 104 can be configured to raise a downward facing surface of furnace chamber 102 sufficiently far from the ground or a supporting surface to reduce/minimize any losses of heat from thermal conductivity between the supporting surface and furnace chamber 102.

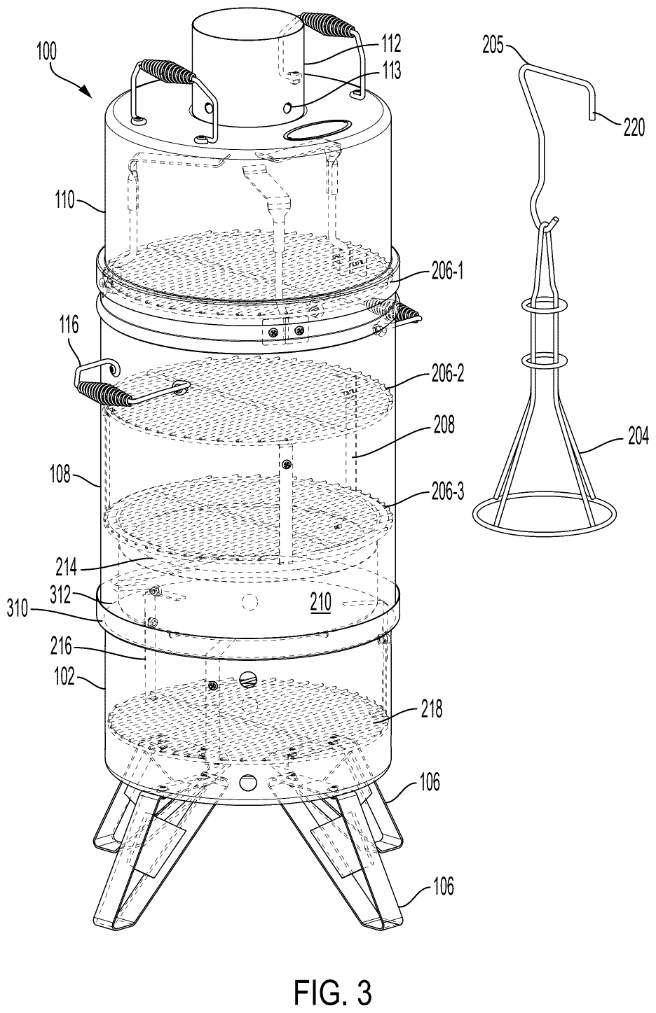

FIG. 1 also shows a perspective view of a cooking chamber 108 that can rest atop furnace chamber 102. Furnace chamber 102 can comprise a widened upper lip portion 103 that can define a narrow shelf 310 (shown in FIG. 3) configured to support a lower periphery 312 (shown in FIG. 3) of a downward facing surface or floor of cooking chamber 108. In some embodiments, the shelf 310 can include a sealing element that helps prevent too much smoke or heat from escaping furnace chamber 102. The cooking chamber 108 and the furnace chamber 102 can each be cup-shaped and can each be cylindrical, and can each comprise a floor. In other aspects, the cooking chamber 108 and/or the furnace chamber 102 can define any other suitable geometry, including, for example or without limitation, a substantially rectangular or square cross-sectional shape. The floor of the cooking chamber 108 prevents direct heating of the cooking chamber 108 and food within the cooking chamber 108 from a heat source, such as burning charcoal briquettes or wood and/or burning gas or propane, within furnace chamber 102 below cooking chamber 108. Food cooker 100 can be formed primarily of stainless steel or other metal and can weigh about 28 pounds, although the materials and weight can vary as desired and should not be considered limiting on the current disclosure.

In some embodiments, the floors and walls of food cooker 100 can define a thickness of between 0.08 and 0.2 inches. FIG. 1 also shows how a lid 110 can be disposed atop cooking chamber 108, thereby defining an enclosed cavity within cooking chamber 108 and lid 110. The enclosed cavity formed by the cooking chamber 108 and lid 110 can be substantially sealed such that smoke from charcoal in the furnace chamber 102 is prevented from entering the enclosed cavity and smoke, moisture, and heated air from within the enclosed cavity is prevented from escaping the enclosed cavity during cooking. Sealing the enclosed cavity from smoke from charcoal allows the use of lighter fluid or other flame starters to be used on the charcoal or other heat source to allow for easier ignition of the heat source without imparting undesired flavoring on the food within the cooking chamber 108. While the enclosed cavity may not be airtight, it can be sufficiently sealed to prevent any appreciable airflow between an interior and an exterior of the cavity.

The lid 110 can comprise a cylindrical heat source container 112 positioned atop an upward-facing surface of lid 110. In other aspects, the heat source container 112 can define any other suitable geometry, including, for example or without limitation, a substantially rectangular or square cross-sectional shape. As depicted, a width/diameter of heat source container 112 is shown smaller than a diameter of lid 110. Heat source container 112 can be sized to accept multiple charcoal briquettes or other heat sources, such as wood, gas, or propane, which can be lit on fire. The heat source container 112 and the furnace chamber 102, in combination, allows for heat to be applied to both top and bottom ends of food cooker 100, thereby generating a heat differential within food cooker 100, which generates a convective current within food cooker 100. In this way, a convective current can be created without the use of a fan, thereby increasing a rate at which food within food cooker 100 is finished cooking. Heat source container 112 is shown including multiple air openings 113 that allow for fresh air to be drawn in to help keep burning charcoal within heat source container 112 burning efficiently during operation of food cooker 100.

FIG. 1 also shows how air openings 114 can be arranged along an upper and lower end of furnace chamber 102 in order to allow air to cycle into and out of furnace chamber 102 as oxygen within furnace chamber 102 is expended by burning charcoal. Both cooking chamber 108 and lid 110 can comprise handles 116 allowing for food cooker 100 to be disassembled while still warm.

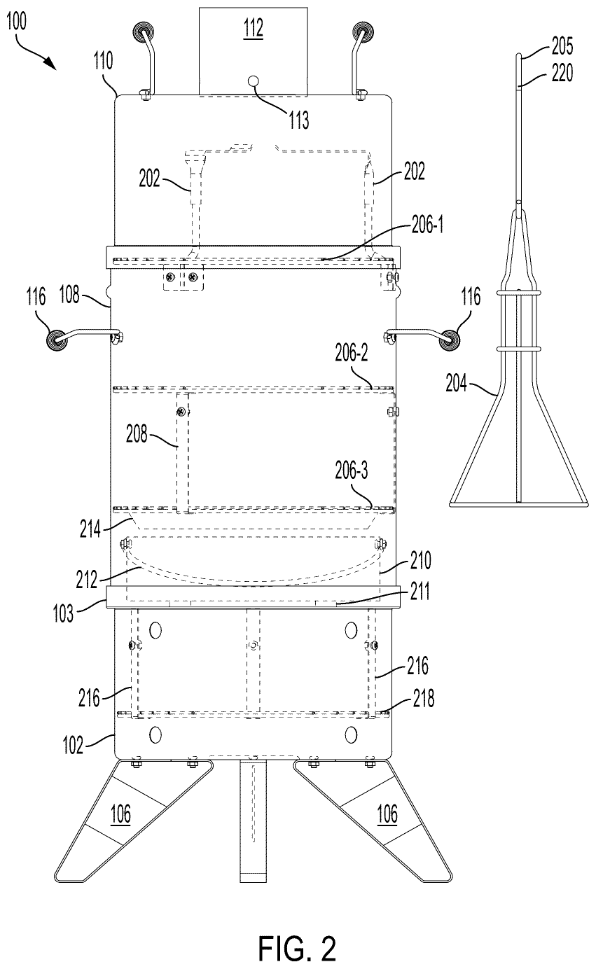

FIG. 2 shows a cross-sectional side view of food cooker 100 indicating positions of components disposed within food cooker 100. In particular, meat hooks 202 are shown occupying an interior volume of food cooker 100 defined by lid 110. Meat hooks 202 are depicted secured to an upper periphery of cooking chamber 108 so that a user of food cooker 100 is able to attach meat such as racks of ribs to meat hooks 202 prior to closing food cooker 100 with lid 110, although in other embodiments, meat hooks 202 may not be present. Further, the meat hooks 202 can be removable from wall brackets spaced around a top end of the cooking chamber 108 such that the meat hooks 202 can be removed by lifting the meat hooks 202 upward.

FIG. 2 also illustrates a poultry stand 204 and a poultry hook 205. The poultry stand 204 and poultry hook 205 are illustrated external to the food cooker 100. According to example aspects, the poultry stand 204 can be placed within the cooking chamber 108 when the user wishes to cook whole chickens or other poultry. This configuration allows a user to hold a whole chicken, turkey, or other poultry upright within a central portion of cooking chamber 108. The optional poultry hook 205 can be provided and is shown hooking a top end of the poultry stand 204. The poultry hook 205 can be used by a user to place the poultry stand 204 into the cooking chamber 108 and to remove the poultry stand 204, or any other object within the cooking chamber 108 in other aspects, from the cooking chamber 108 after cooking, when the poultry stand 204 would be too hot to handle by hand. A distal end 220 of the poultry stand 204 can be hooked through an opening formed through the lid 110, and more specifically, hooked through one of the air openings 113 formed through the heat source container 112 in the present aspect. While shown in FIG. 2, the poultry hook 205 may not be present when the lid 110 is positioned on top of the cooking chamber 108.

FIG. 2 also shows how multiple circular gratings can be arranged within cooking chamber 108. As depicted, cooking chamber 108 can comprise mounting points for up to three gratings 206. It should be appreciated that a large variety of different kinds of food can be supported by gratings 206. For example, a number of skewers can be arranged across a surface of one of gratings 206 and include foods such as cubed meat, onions, tomatoes, peppers, and the like. Other foods that can be placed on one or more gratings 206 include pork butts, beef brisket, and chicken wings.

Gratings 206 can be suspended within cooking chamber 108 by one or more U-brackets 208. The gratings 206 can be selectively removable in example aspects. For example, gratings 206-2 and 206-3 are shown being supported by a U-bracket 208. A first end of U-bracket 208 arranged closer to an upward facing end of cooking chamber 108 is shown supporting grating 206-2, while a second end of U-bracket 208 arranged closer to a downward facing end of cooking chamber 108 is shown supporting grating 206-3. It should be appreciated U-brackets 208 could be arranged at different elevations within cooking chamber 108 in order to give additional options as to where to position each of gratings 206 within cooking chamber 108. Further, the top grating 206-1 can rest on the wall brackets in which the meat hooks 202 can be placed and secured, typically after the meat hooks 202 are removed. In other embodiments, individual brackets for each level of gratings 206 can be present instead of U-brackets 208.

One of the gratings 206, such as grating 206-3, can be used to support poultry stand 204, with the other gratings 206 optionally removed. However, in some embodiments, one or more gratings 206 can have an annular geometry with central openings arranged to accommodate the passage of poultry stand 204. A configuration that includes poultry stand 204 and gratings 206 with annular geometries can allow for placement of a larger amount of food within food cooker 100.

FIG. 2 also shows a position of drip pan 210 positioned proximate to, such as on or above, the floor of cooking chamber 108. As depicted, drip pan 210 is operable to collect most juices and rendered fat dripping from food positioned within cooking chamber 108. Heat transfer between the charcoal within furnace chamber 102 and the food within cooking chamber 108 can be limited to indirect heating, both thermal and conductive through the floor of the cooking chamber 108, which is positioned between an interior of the cooking chamber 108 and the furnace chamber 102, as described above. As can be appreciated, this configuration can result in drip pan 210 absorbing a substantial amount of radiated heat generated within furnace chamber 102 resulting in some drippings collecting within drip pan 210 being vaporized to generate a desired amount of steam within cooking chamber 108, thereby preventing a “stall” associated with other methods of slow-cooking meat, such as smoking. The “stall” may occur when juices trapped within meat begin to vaporize and escape the meat once the meat reaches a certain temperature. This vaporization causes evaporative cooling of the meat, preventing the temperature of the meat from rising past this temperature for as much as six hours. By trapping evaporation within the cooking chamber 108 through a combination of evaporations from the drip pan 210 and the food itself, moisture is prevented from evaporating from the meat within the cooking chamber 108 because the air within the cooking chamber 108 is already at maximum humidity levels, and thus the meat can easily move past temperatures at which the “stall” takes place, speeding up the cooking time. In some aspects, water or other liquid can be added to the drip pan 210 prior to cooking to add moisture to the interior of the cooking chamber 108 during cooking, such as when cooking beef brisket or seafood. In some aspects, the drip pan can comprise a stainless steel material, for example and without limitation. In some aspects, the drip pan can be disposable or can comprise a disposable lining.

In some embodiments, the drip pan 210 can be positioned on a stand 211, such as a metal ring, truncated cone, L-brackets, or a cylinder, that is resting and/or welded or otherwise fixed to the floor of the cooking chamber 210 or on brackets attached to the wall of the cooking chamber 210, to space the drip pan 210 from the floor of the cooking chamber 108 and limit the amount of heat transferred directly to the drip pan 210 to prevent overheating and possible burning or scorching of the contents of the drip pan 210. In other aspects, the stand 211 can instead be welded or otherwise attached to a bottom of the drip pan 210. In other aspects, legs can be attached to the bottom of the drip pan 210, and the legs can engage the floor of the cooking chamber 108 to support the drip pan 210 above the floor.

Drip pan 210 is also shown including its own handle 212 that can be configured to easily removal and emptying of drip pan 210 after cooking. If smoke flavor is desired in the food within the cooking chamber 108, wood chips can be positioned around and/or below drip pan 210 on the floor of the cooking chamber 108, which will smoke during cooking from heat passing through the floor of the cooking chamber 108 from the furnace chamber 102. Because the wood chips are in direct contact with the lower end or floor of the cooking chamber 108, which is directly heated by heat source within the furnace chamber 102, the wood chips will heat quicker and to a higher temperature than food held above the lower end of the cooking chamber 108, causing them to burn and generate smoke. Smoke generated from the wood chips can help flavor food positioned within cooking chamber 108. Further, a grease ring 214 can be mounted above the drip pan 210. The grease ring 214 can be a truncated conical ring tapering downwards and radially inwards over the drip pan 210. The grease ring 214 can prevent drippings from food within the cooking chamber 108 from dripping down between the drip pan 210 and the side wall of the cooking chamber 108, thereby preventing the wood chips from becoming wet, which can prevent the wood chips from smoking and adding flavor to the food.

FIG. 2 also depicts how furnace chamber 102 can include the one or more support brackets 216 configured to support a charcoal grating 218 near a bottom of furnace chamber 102. In some aspects, in combination with the widened upper lip portion 103, the one or more support brackets 216 may also support the cooking chamber 108. Support brackets 216 can be sized to establish a desired spacing interval between charcoal grating 218 and the floor of cooking chamber 108 as well as an interval between charcoal grating 218 and a bottom of furnace chamber 102, which can allow for ash to accumulate below the charcoal grating 218 during use of the food cooker 100. In other embodiments, the support brackets 216 may only support the charcoal grating 218 and only the widened upper lip portion 103 of the furnace chamber 102 supports the cooking chamber 108. For example, in some aspects, the support brackets 216 may only include portions that extend inward into the cooking chamber 108 proximate to a bottom of furnace chamber 102, and do not include any other portion that extends inward, so that the support brackets 216 only support the charcoal grating 218. Further, for example, in some aspects, the support brackets 216 may not include any portion that extends upward towards a top of the furnace chamber 102, and may only include portions that are mounted proximate to a bottom of the furnace chamber 102. The one or more support brackets 216 can define an inverted L-shape in some aspects.

As shown, the furnace chamber 102 can be entirely below the floor of the cooking chamber 108, and a diameter of the furnace chamber 102 can be equal to or less than a diameter of the cooking chamber 108. This configuration allows efficient direct heating of the floor of the cooking chamber 108 to thereby heat food within the enclosed cavity of the cooking chamber 108 and the lid 110. By placing the heat source directly below the floor of the cooking chamber 108 in the furnace chamber 102, less charcoal is required than previous configurations of food cookers. In other aspects, the diameter of the furnace chamber 102 can be greater than the diameter of the cooking chamber 108.

In example aspects, a method of cooking a food item with the food cooker 100 can comprise removing the lid 110 from the cooking chamber 108 and supporting the food item within an interior the cooking chamber 108. For example, supporting the food item within the cooking chamber 108 can comprise supporting the food item on one of the gratings 206 or one or more of the meat hooks 202. In some aspects, separate food items can be placed on multiple gratings 206, such as placing a first Boston butt on a lower grating 206-3 and then placing a second Boston butt on a middle grating 206-2 and finally placing a third Boston butt on the top grating 206-1. In example aspects, the removable grating(s) 206 can be inserted into and mounted within the cooking chamber 108 prior to supporting the food item on the grating 206. The lid 110 can be re-assembled with the cooking chamber 108 after receiving the food item within the cooking chamber 108. The lid 110 can be re-assembled with the cooking chamber 108 before or after placing the cooking chamber 108 back on top of the furnace chamber 102.

In some aspects, wood chips can be inserted into the cooking chamber 108 and arranged around and/or below the drip pan 210 prior to supporting the food item within the cooking chamber 108. In other aspects, the wood chips may not be used. Additionally, in some aspects, the method can further comprise adding water or another liquid to the drip pan 210. The water or other liquid may be added to the drip pan 210 before or after supporting the food item within the cooking chamber 108. Example aspects of the method can also comprise mounting the grease ring 214 above the drip pan 210 prior to supporting the food item within the cooking chamber 108.

The method can further comprise removing the cooking chamber 108 and the lid 110 from the furnace chamber 102 to allow access to an interior of the furnace chamber 102 through an open top end thereof. The cooking chamber 108 and the lid 110 can be removed from the furnace chamber 102 prior to or after supporting the food item within the cooking chamber 108. Charcoal, such as match-light charcoal, or any other suitable heat source, can then be inserted into the interior of the furnace chamber 102 through the open top end.

The charcoal can then be ignited. In some aspects, the food item can be supported within the cooking chamber 108 prior to receiving the charcoal in the furnace chamber 102 and/or igniting the charcoal. In other aspects, the charcoal can be received within the furnace chamber 102 and/or can be ignited prior to supporting the food item within the cooking chamber 108.

The charcoal can be ignited before or after re-assembling the cooking chamber 108 and the lid 110 with the furnace chamber 102. For example, in some example aspects, the charcoal can be ignited (such as by a match or lighter) through the open top end of the furnace chamber 102 prior to placing the cooking chamber 108 and the lid 110 back on top of the furnace chamber 102. In other aspects, the charcoal can be ignited through the air opening 114 before or after placing the cooking chamber 108 and the lid 110 back on top of the furnace chamber 102.

In aspects wherein the charcoal is ignited prior to placing the cooking chamber 108 and the lid 110 back on top of the furnace chamber 102, the charcoal may be pre-heated within the furnace chamber 102 for a period of time before re-assembling the cooking chamber 108 and the lid 110 with the furnace chamber 102. In other aspects, the charcoal may not be pre-heated prior to re-assembling the cooking chamber 108 and the lid 110 with the furnace chamber 102

In other aspects, the charcoal can be ignited prior to inserting the charcoal into the interior of the furnace chamber 102. For example and without limitation, in a particular aspect, the charcoal can be ignited by a charcoal chimney, and the charcoal can be pre-heated within the charcoal chimney prior to inserting the charcoal into the furnace chamber 102.

As described above, the cooking chamber 108 can be re-assembled with the furnace chamber 102 after receiving the charcoal within the furnace chamber 102. The charcoal can be ignited within the furnace chamber 102 before or after re-assembling the cooking chamber 108 with the furnace chamber 102. The lid 110 can be re-assembled with the cooking chamber before or after the cooking chamber 108 is re-assembled with the furnace chamber 102, such that the cooking chamber can be placed back on top of the furnace chamber 102 with or without the lid 110 supported thereon.

The method can further comprise adding charcoal or another suitable heat source to the heat source container 112 of the lid 110, before or after reassembling the lid 110 with the cooking chamber 108 and before or after reassembling the cooking chamber 108 with the furnace chamber 102. Once the cooking chamber 108 and the lid 110 are assembled together and both are mounted back on top of the furnace chamber 110, the charcoal within the heat source container 112 can be ignited. In other aspects, the charcoal within the heat source container 112 can be ignited prior to placing the lid 110 on the cooking chamber 108. The burning charcoal in the furnace chamber 102 and the heat source container 112 can heat and cook the food item within the interior of the cooking chamber 108.

FIG. 3 shows a perspective view of food cooker 100 with internal and hidden components depicted in dashed lines. In particular, FIG. 3 shows the grease ring 214 above the drip pan 210 and below the grating 206-3. The grease ring 214 can be mounted on the same U-bracket 208 as the grating 206-3 such that the grating 206-3 can rest on top of the grease ring 214.

As also shown in FIG. 3, the furnace chamber 102 can comprise the widened upper lip portion 103. The widened upper lip portion 103 can define the shelf 310, which can support the lower periphery 312 of a downward facing surface or floor of cooking chamber 108. In some example aspects, as previously described, the shelf 310 can include a sealing element that can help prevent too much smoke or heat from escaping furnace chamber 102 around the shelf 310, so that smoke primarily exits through the air openings 114.

Modifications, additions, or omissions may be made to the food cooker as described without departing from the scope of the present disclosure.

A number of implementations have been described. Nevertheless, it will be understood that various modifications may be made without departing from the spirit and scope of the disclosure. Accordingly, other implementations are within the scope of the following claims.

In accordance with common practice, the various features illustrated in the drawings may not be drawn to scale. The illustrations presented in the present disclosure are not meant to be actual views of any particular apparatus (e.g., device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or all operations of a particular method.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes”should be interpreted as “includes, but is not limited to,”etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc. ” or “one or more of A, B, and C, etc. ” is used, in general such a construction is intended to include A alone, B alone, C alone, A and B together, A and C together, B and C together, or A, B, and C together, etc. For example, the use of the term “and/or”is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. A food cooker, comprising:
a cooking chamber;
a furnace chamber disposed below the cooking chamber;
a lid covering a top opening of the cooking chamber, the lid and the cooking chamber defining an enclosed cavity; and
a food-supporting element within the enclosed cavity.

2. The food cooker of claim 1, further comprising a drip pan positioned proximate to a floor of the cooking chamber.

3. The food cooker of claim 2, wherein a width of the drip pan is narrower than a width of the cooking chamber.

4. The food cooker of claim 3, wherein the drip pan is supported by a stand positioned between the drip pan and a floor of the furnace chamber.

5. The food cooker of claim 1, further comprising a support stand comprising a plurality of legs coupled directly to the furnace chamber and arranged along a bottom of the furnace chamber at a regular radial interval.

6. The food cooker of claim 1, wherein the cooking chamber and the furnace chamber both define cylindrical geometries.

7. The food cooker of claim 1, wherein the food-supporting element comprises at least one of a circular cooking grate and a meat hanger.

8. The food cooker of claim 7, wherein the meat hanger is one of a plurality of meat hangers, and wherein the plurality of meat hangers are distributed radially around the cooking chamber.

9. The food cooker of claim 1, wherein a width of the furnace chamber is the same as or less than a width of the cooking chamber.

10. The food cooker of claim 1, wherein the furnace chamber comprises a plurality of openings extending through a sidewall of the furnace chamber and configured to allow fresh air to be drawn into the furnace chamber during operation of the food cooker.

11. The food cooker of claim 10, wherein:
the furnace chamber comprises a charcoal grate extending across the furnace chamber;
the charcoal grate is configured to support burning charcoal within the furnace chamber; and
the plurality of openings in the sidewall of the furnace chamber are positioned both above and below the charcoal grate.

12. The food cooker of claim 11, wherein:
the furnace chamber further comprises a plurality of brackets secured to the sidewall of the furnace chamber; and
a first end of each of the plurality of brackets is configured to support the charcoal grate above a floor of the furnace chamber.

13. The food cooker of claim 1, wherein:
the furnace chamber comprises a widened upper lip portion;
the widened upper lip portion defines an upper shelf; and
a lower periphery of the cooking chamber is supported on the upper shelf of the furnace chamber.

14. The food cooker of claim 1, wherein the lid comprises a heat source container.

15. The food cooker of claim 14, wherein the heat source container defines one or more air openings configured to allow fresh air to be drawn into the heat source container.

16. The food cooker of claim 15, further comprising a poultry stand and a poultry hook, the poultry hook supporting the poultry stand within the cooking chamber, a distal end of the poultry hook engaging a corresponding air opening of the one or more air openings.

17. A method of cooking a food item, the method comprising:
providing a food cooker, the food cooker comprising:
a cooking chamber;
a furnace chamber disposed below the cooking chamber;
a lid covering a top opening of the cooking chamber, the lid and the cooking chamber defining an enclosed cavity; and
a food-supporting element within the enclosed cavity;
placing charcoal within the furnace chamber;
igniting the charcoal;
supporting a food item on the food-supporting element within the enclosed cavity; and
heating an interior of the enclosed cavity with the ignited charcoal to cook the food item.

18. The method of claim 17, wherein:
before placing charcoal within the furnace chamber, the method further comprises moving the cooking chamber away from the furnace chamber; and
after placing charcoal within the furnace chamber, the method further comprises moving the cooking chamber to a position above the furnace chamber.

19. The method of claim 17, wherein:
the food cooker further comprises a charcoal grate extending across the furnace chamber above a floor of the furnace chamber; and
receiving charcoal within the furnace chamber comprises supporting the charcoal on the charcoal grate.

20. The method of claim 17, wherein:
the lid comprises a heat source container; and
the method further comprises heating a heat source within the heat source container to further heat the interior of the enclosed cavity and cook the food item.
